(19) United States
(12) Patent Application Publication
(10) Pub. No.: US 2024/0014371 A1
(43) Pub. Date: Jan. 11, 2024

(54) METHODS AND SYSTEMS FOR PRODUCING LITHIUM INTERCALATED ANODES

(71) Applicant: Applied Materials, Inc., Santa Clara, CA (US)

(72) Inventors: PrasannaKalleshwara Buddappa RAMACHANDRAPPA, Santa Clara, CA (US); Sambhu Nath KUNDU, Fremont, CA (US); Visweswaren SIVARAMAKRISHNAN, Cupertino, CA (US); Subramanya P. HERLE, Mountain View, CA (US)

(21) Appl. No.: 18/199,749

(22) Filed: May 19, 2023

Related U.S. Application Data
(60) Provisional application No. 63/388,114, filed on Jul. 11, 2022.

(51) Int. Cl. H01M 4/04

(52) U.S. Cl. CPC H01M 4/0435; H01M 4/0471; H01M 4/0485; H01M 2004/027

(57) ABSTRACT

Embodiments of the present disclosure generally relate to battery technology, and more specifically, methods and systems for preparing lithium anodes. In one or more embodiments, a method for producing a lithium intercalated anode includes introducing a sacrificial substrate containing lithium films and an anode substrate containing graphite into a processing region within a chamber. The method also includes combining the sacrificial and anode substrates overlapping one another around a rewinder roller, rotating the rewinder roller to wind the sacrificial and anode substrates together to produce a rolled anode-sacrificial substrate bundle during a winding process. The method also includes heating the sacrificial substrate, the anode substrate, and/or the rolled anode-sacrificial substrate bundle while rotating the rewinder roller and applying a force to the rolled anode-sacrificial substrate bundle via an idle roller during the winding process.

### CROSS-REFERENCE TO RELATED APPLICATIONS

This application claims benefit to U.S. Prov. Appl. No. 63/388,114, filed on Jul. 11, 2022, which is herein incorporated by reference.

### BACKGROUND

### Field

Embodiments of the present disclosure generally relate to battery technology, and more specifically, methods and systems for preparing lithium anodes.

### Description of the Related Art

Battery technologies, including rechargeable electrochemical storage systems, are currently becoming increasingly valuable for many fields of everyday life. High-capacity electrochemical energy storage devices, such as lithium-ion (Li-ion) batteries, are used in a growing number of applications, including electric vehicles (EVs), portable electronics, medical, transportation, grid-connected large energy storage, renewable energy storage, and uninterruptible power supply (UPS). Traditional lead/sulfuric acid batteries often lack the capacitance, have too much weight, and are often inadequately cycleable for these growing applications. Lithium-ion batteries, however, are thought to have the best chance.

Typically, lithium-ion batteries do not contain solid metallic lithium anodes for safety reasons but instead use a graphitic material containing lithium as the anode. However, the use of graphite, which, in the charged state can be charged up to the limit composition LiC₆, results in a much lower capacity, in comparison with the use of metallic lithium anodes. Currently, the industry is moving away from graphitic-based anodes to silicon-blended graphite to increase energy cell density. However, silicon blended graphite anodes suffer from first cycle capacity loss. Thus, there is a need for lithium metal deposition to replenish first cycle capacity loss of silicon blended graphite anodes. However, lithium metal faces several device integration challenges.

Lithium is an alkali metal and similar to the other the first main group elements, lithium is characterized by a strong reactivity with a variety of substances. Lithium reacts violently with water, alcohols, and other substances that contain protic hydrogen, often resulting in ignition. Lithium is unstable in air and reacts with oxygen, nitrogen, and carbon dioxide. Lithium is normally handled under an inert gas atmosphere (noble gases such as argon) and the strong reactivity of lithium necessitates that other processing operations also be performed in an inert gas atmosphere. As a result, lithium provides several challenges when coming to processing, storing, and/or transporting lithium.

Therefore, there is need for improved methods and systems for producing lithium intercalated anodes.

### SUMMARY

Embodiments of the present disclosure generally relate to battery technology, and more specifically, methods and systems for preparing alkaline anodes, such as lithium anodes. In one or more embodiments, a method of forming or otherwise producing a lithium intercalated anode is provided and includes introducing a sacrificial substrate into a processing region within a chamber and introducing an anode substrate into the processing region within the chamber. The sacrificial substrate can be or include a base foil having an upper surface opposite a lower surface and a lithium coating disposed on the upper and lower surfaces. The anode substrate can contain graphite or a graphite material. The method also includes combining the sacrificial substrate and the anode substrate overlapping one another around a rewinder roller within the processing region during a rolling or winding process. The method further includes rotating the rewinder roller to wind the sacrificial substrate and the anode substrate together to produce a rolled anode-sacrificial substrate bundle while continuing to introduce the sacrificial substrate and the anode substrate into the processing region during the rolling or winding process. The method also includes heating the sacrificial substrate, the anode substrate, and/or the rolled anode-sacrificial substrate bundle while rotating the rewinder roller and applying a force to the rolled anode-sacrificial substrate bundle via an idle roller during the rolling or winding process.

In other embodiments, a method of forming or otherwise producing a lithium intercalated anode is provide and includes introducing a sacrificial substrate into a processing region within a chamber, where the sacrificial substrate can be or contain one a base foil having an upper surface opposite a lower surface and a lithium coating disposed on the upper and lower surfaces and introducing an anode substrate into the processing region within the chamber. The method also includes rotating a rewinder roller within the processing region to wind the sacrificial substrate and the anode substrate together and overlapping one another around to produce a rolled anode-sacrificial substrate bundle while continuing to introduce the sacrificial substrate and the anode substrate into the processing region during a rolling process. The processing region is maintained under a vacuum of less than 760 Torr, such as at a pressure in a range from about 1×10⁻⁶ mTorr to about 1×10⁻³ mTorr, while producing the rolled anode-sacrificial substrate bundle. The method further includes heating the sacrificial substrate, the anode substrate, and/or the rolled anode-sacrificial substrate bundle while rotating the rewinder roller during the rolling process and applying a force to the rolled anode-sacrificial substrate bundle via an idle roller during the rolling process. The method further includes transferring at least a portion of the lithium metal from the sacrificial substrate to the anode substrate and absorbing the lithium metal into the anode substrate to produce a lithium intercalated anode substrate.

In some embodiments, a system for forming or otherwise producing a lithium intercalated anode is provided and includes a chamber having a processing region therein and configured to maintained the processing region under a vacuum, such as at a pressure of less than ambient pressure (e.g., <760 Torr). The system also includes a first source coupled to the chamber and containing a sacrificial substrate containing a base foil having an upper surface opposite a lower surface and a lithium coating disposed on the upper and lower surfaces, and a second source coupled to the chamber and containing an anode substrate containing graphite. The system further includes a rewinder roller disposed within the processing region and configured to receive and wind together the sacrificial substrate and the anode substrate to produce a rolled anode-sacrificial substrate bundle, a calendaring system containing an idle roller configured to apply a force to the rolled anode-sacrificial substrate bundle, and one or more infrared lamps contained within the processing region and positioned at the sacrificial substrate, the anode substrate, and/or the rolled anode-sacrificial substrate bundle.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 depicts a schematic view of a process system for forming a rolled anode-sacrificial substrate bundle as an intermediate to a lithium intercalated anode, according to one or more embodiments as described and discussed herein.

FIG. 2A depicts a schematic view of a rolled anode-sacrificial substrate bundle, according to one or more embodiments as described and discussed herein.

FIG. 2B depicts a schematic view of a sacrificial substrate, according to one or more embodiments as described and discussed herein.

FIG. 3 depicts a perspective view of a calendaring system which can be used in process systems for forming a rolled anode-sacrificial substrate bundle, according to one or more embodiments as described and discussed herein.

FIGS. 4A-4E depict multiple views of the calendaring system, as illustrated in FIG. 3, contained within a process system for forming a rolled anode-sacrificial substrate bundle, according to one or more embodiments as described and discussed herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to battery technology, and more specifically, methods and systems for preparing alkaline anodes, such as lithium intercalated anodes. The methods include lithium transfer from a sacrificial substrate to an anode substrate by a heated lamination technique. Typically, the lithium is transferred from the sacrificial substrate to the anode substrate within a reel-to-reel (R2R) vacuum chamber or other process chamber. In one or more examples, lithium is the alkaline metal transferred to the anode substrate to produce a lithium intercalated anode. However, in some examples, the method can be utilized to transfer other alkaline metals (e.g., sodium, potassium, or cesium) to an anode substrate.

In one or more embodiments, methods for producing or otherwise forming a lithium intercalated anode includes introducing a sacrificial substrate and an anode substrate into a processing region under vacuum within a chamber. The sacrificial substrate can contain a base foil having an upper surface opposite a lower surface and a lithium coating disposed on the upper and lower surfaces. The anode substrate can be or contain graphite or one or more graphite-containing materials. The method also includes winding the sacrificial substrate and the anode substrate together to produce a rolled anode-sacrificial substrate bundle while heating the sacrificial substrate, the anode substrate, and/or the rolled anode-sacrificial substrate bundle and applying a force to the rolled anode-sacrificial substrate bundle during the rolling or winding process. During a predetermined period of time, the rolled anode-sacrificial substrate bundle is maintained under vacuum while at least a portion of the lithium metal is transferred from the sacrificial substrate to the anode substrate and absorbed into the anode substrate to produce a lithium intercalated anode substrate. The base foil and any remaining lithium metal thereon can be separated from the lithium intercalated anode substrate.

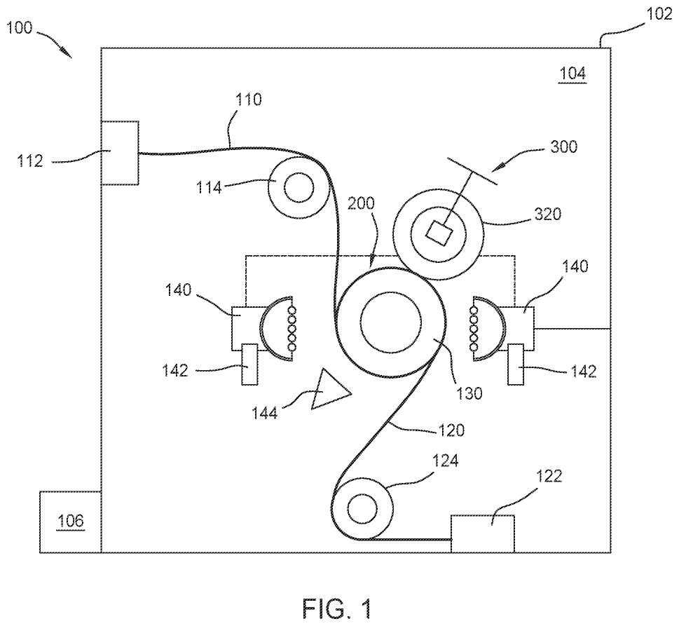

FIG. 1 depicts a schematic view of a process system 100 for forming a rolled anode-sacrificial substrate bundle as an intermediate to a lithium intercalated anode, according to one or more embodiments as described and discussed herein. In one or more embodiments, the process system 100 for forming or otherwise producing the lithium intercalated anode is provided and includes a chamber 102, such as a rewinder chamber, having one or more processing regions 104 therein. The chamber 102 is configured to maintain the processing region 104 under a vacuum, such as at a pressure of less than ambient pressure (e.g., <760 Torr). One or more vacuum pumps 106 are coupled to and in fluid communication with the chamber 102 and configured to control the pressure of the processing region 104. In one or more embodiments, the process system 100 contains a process chamber (not shown) coupled to and between an unwinder chamber (not shown) and the chamber 102 (e.g., a rewinder chamber).

The process system 100 also includes two or more sources 112, 122 of various substrates utilized during the processing techniques described and discussed here. The process system 100 includes a first source 112 of a sacrificial substrate 110 coupled to the chamber 102. The first source 112 contains and/or provides the sacrificial substrate 110. In some examples, the first source 112 can be outside of the chamber 102 and provides the sacrificial substrate 110 into the processing region 104. The process system 100 also includes a second source 122 of an anode substrate 120 coupled to the chamber 102. The second source 122 contains and/or provides the anode substrate 120. In some examples, the second source 122 can be outside of the chamber 102 and provides the anode substrate 120 into the processing region 104.

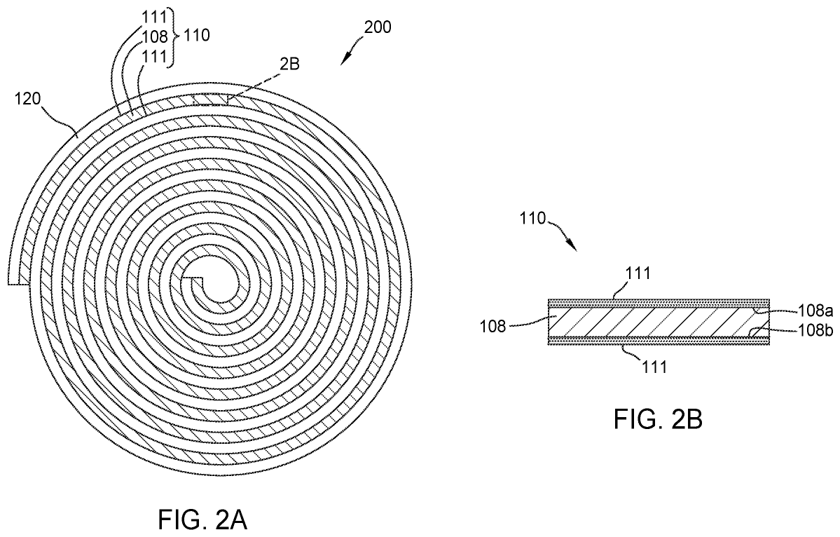

FIG. 2A depicts a schematic view of a rolled anode-sacrificial substrate bundle 200 once removed from the rewinder roller 130, and FIG. 2B depicts a schematic view of the sacrificial substrate 110, according to one or more embodiments as described and discussed herein. In one or more embodiments, the sacrificial substrate 110 contains a base foil 108 having an upper surface 108a opposite a lower surface 108b and a lithium coating 111 disposed on the upper and lower surfaces 108a, 108b, as depicted in Figured 2A-2B. The lithium coating 111 can be or contain metallic lithium or a lithium alloy. In other embodiments, the lithium coating 111 can be replaced with another metal film disposed on the upper and lower surfaces 108a, 108b. For example, one or more metals, including one or more alkaline metals) can be disposed on the upper and lower surfaces 108a, 108b and used to form the rolled anode-sacrificial substrate bundle 200 and subsequently produce the respective metal anode substrate. Exemplary metals can be or include lithium, sodium, potassium, cesium, alloys thereof, or any combination thereof.

In one or more embodiments, the base foil 108 of the sacrificial substrate 110 can be or contain one or more metals and/or one or more polymeric materials. For example, the base foil 108 can be or contain one or more metals, such as copper, one or more copper alloys, nickel, one or more nickel alloys, one or more stainless steel alloys, alloys thereof, or any combination thereof. In other examples, the base foil 108 can be or contain one or more polymeric materials, such as polyethylene terephthalate (PET), polypropylene (PP), copolymers thereof, elastomers thereof, or any combination thereof. In one or more examples, the base foil 108 can be or contain a copper foil or sheet and/or a PET foil or sheet. In one or more embodiments, the anode substrate 120 can be or include graphite, graphite foil, graphite sheet, silicon-graphite material, silicon oxide-graphite material, or any combination thereof. In one or more examples, the anode substrate 120 can be or include a graphite foil and/or a silicon-graphite foil.

The process system 100 and/or the chamber 102 further includes a rewinder roller 130 disposed within the processing region 104. The rewinder roller 130 is configured to receive and wind together the sacrificial substrate 110 and the anode substrate 120 to produce or otherwise form a rolled anode-sacrificial substrate bundle 200 wrapped around the rewinder roller 130. In one or more examples, the chamber 102 is a rewinder chamber the processing region 104 and the rewinder roller 130 are both contained within the rewinder chamber.

The process system 100 can include one or more rollers 114 to assist in delivering, transporting, and/or supporting the sacrificial substrate 110 and one or more rollers 124 to assist in delivering, transporting, and/or supporting the anode substrate 120. As depicted in FIG. 1, the roller 114 can be positioned between the first source 112 and the rewinder roller 130 and configured to assist in supporting and delivering the sacrificial substrate 110 to the rewinder roller 130. Similarly, the roller 124 can be positioned between the second source 122 and the rewinder roller 130 and configured to assist in supporting and delivering the anode substrate 120 to the rewinder roller 130.

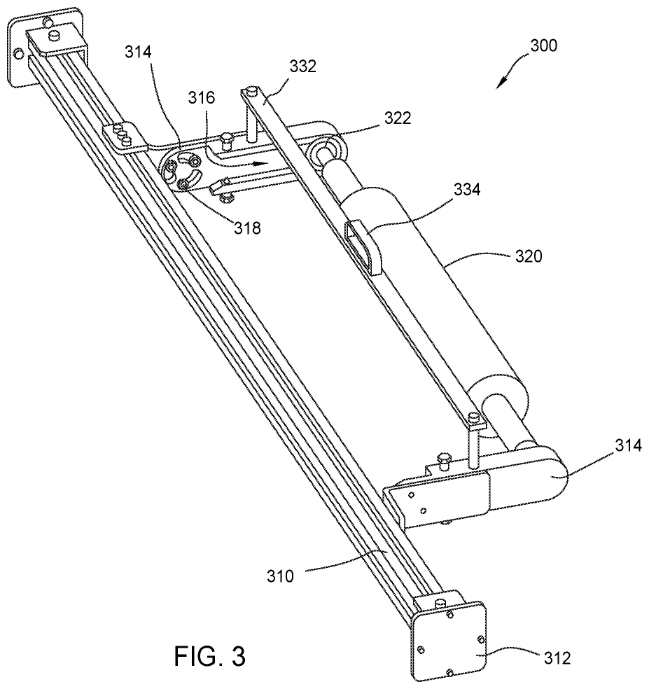

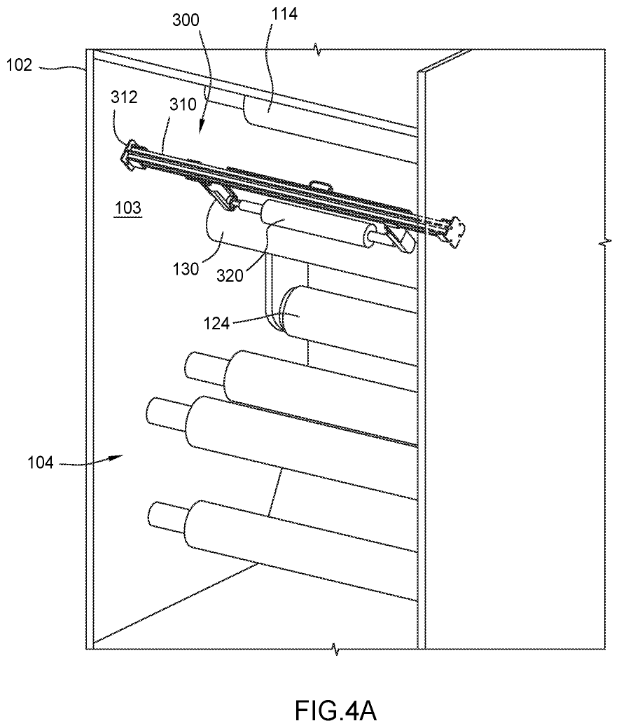

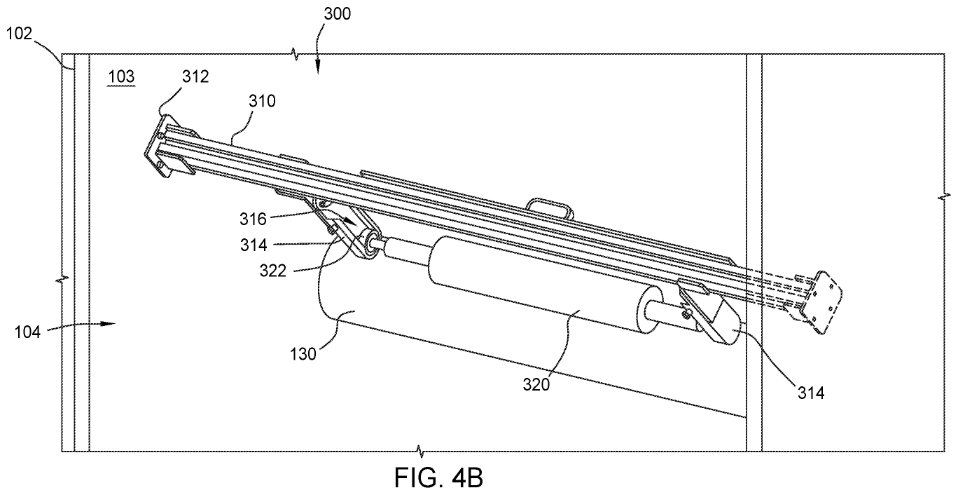

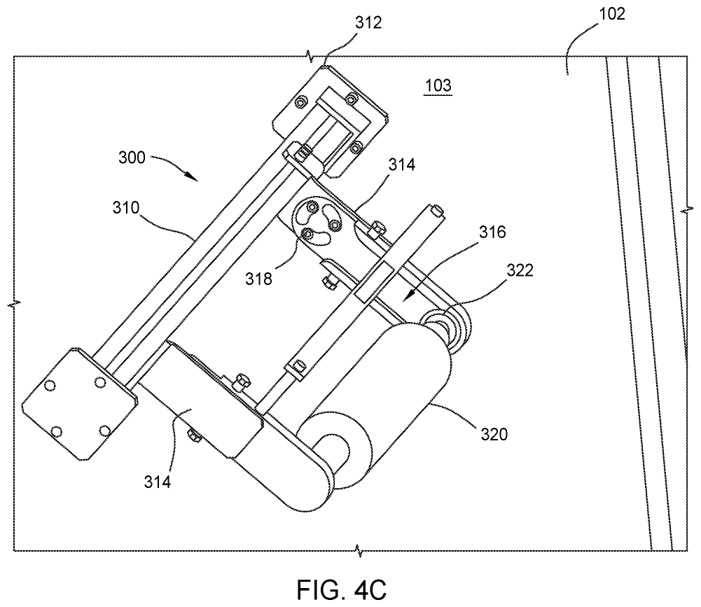

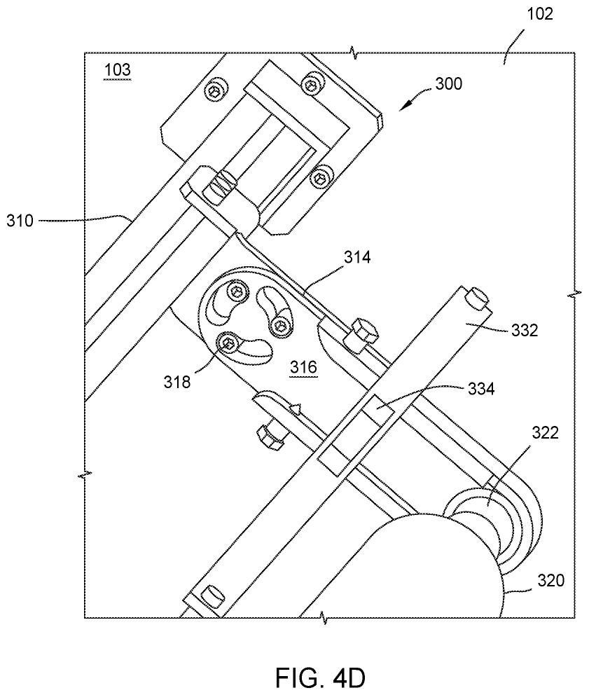

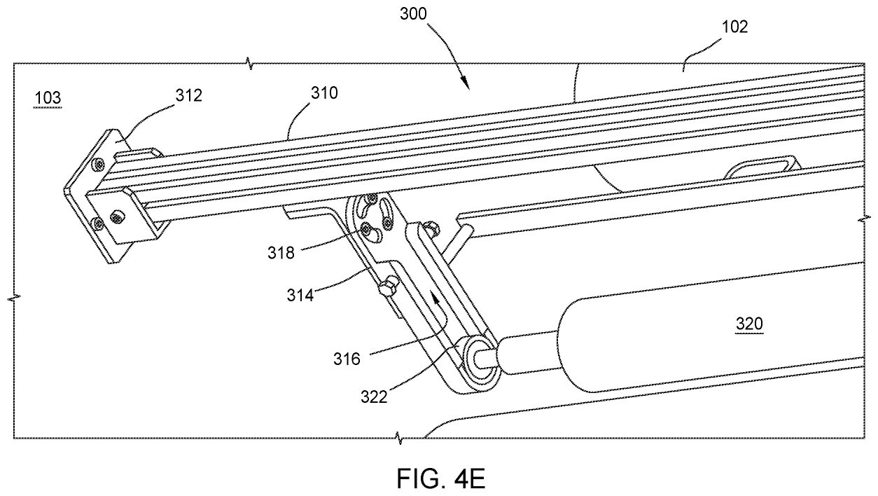

The process system 100 includes a calendaring system 300 containing a dead weight or an idle roller 320 configured to apply a force to the rolled anode-sacrificial substrate bundle 200 during the process of winding together the sacrificial substrate 110 and the anode substrate 120, as depicted in FIG. 1. FIG. 3 depicts a perspective view of a calendaring system 300 which can be used in a variety of different process systems, such as the process system 100 for forming the rolled anode-sacrificial substrate bundle 200, according to one or more embodiments as described and discussed herein. FIGS. 4A-4E depict multiple views of the calendaring system 300 contained within the process system 100, according to one or more embodiments as described and discussed herein.

The calendaring system 300 contains a support beam 310, two pivot arms 314 coupled to the support beam 310, and the idle roller 320 coupled to and between the pivot arms 314. One, two, or more brackets 312 can be used to support, couple, or attach support the support beam 310 to inner surfaces 103 within the process system 100. As shown in Figured 4A-4C, each end of the support beam 310 is held by a respective bracket 312 which in turn is attached to the inner surfaces 103 of the process system 100 by a plurality of fasteners (e.g., bolts, screws, rivets). The calendaring system 300 also contains a bar 332 coupled to and between the pivot arms 314, such as attached to the upper surface of each pivot arm 314. A handle 334 is coupled to the bar 332 and configured to adjust the angle of the pivot arms 314 relative to the support beam 310. A plurality of adjustment bolts 318 disposed on or near the end of each pivot arm 314 closest to the support beam 310. The adjustment bolts 318 can be loosened, then the pivot arms 314 can be manually adjusted via the handle 334 to the desired angle, and then the adjustment bolts 318 can be tightened to secure the desired angle of the pivot arms 314.

The inner surface on each of the pivot arms 314 includes a track or sliding slot 316 extending most of the length of the pivot arm and configured to support the idle roller 320. The calendaring system 300 also contains two casters 322 coupled to the idle roller. Each of the casters 322 is coupled on opposite ends of the idle roller 320 and configured to assist the idle roller 320 to be mobile. Each of the casters 322 is configured to travel within a respective track or sliding slot 316 on each of the pivot arms 314.

In one or more examples, the idle roller 320 is positioned within the process system 100 and configured to radially move away from the rewinder roller 130 as the diameter of the rolled anode-sacrificial substrate bundle 200 increases during production from the sacrificial substrate 110 and the anode substrate 120. In addition, the idle roller 320 maintains a controlled force applied to the rolled anode-sacrificial substrate bundle 200 during production.

In some examples, the idle roller 320 can be replaced with rollers of various weights in order to select a desired force applied to the rolled anode-sacrificial substrate bundle 200 during the rolling or winding process. For example, the idle roller 320 can have a mass of about 5 kg, about 10 kg, or about 15 kg to about 20 kg, about 25 kg, about 30 kg, or greater. In one or more examples, the idle roller 320 has a mass of about kg to about 30 kg, about 10 kg to about 20 kg, or about 20 kg to about 30 kg.

In one or more embodiments, the idle roller 320 can apply a predetermined force to the rolled anode-sacrificial substrate bundle 200 during the rolling or winding process. For example, the idle roller 320 can apply a force in a range from about 40 pounds per square inch (PSI), about 50 PSI, about 60 PSI, about 80 PSI, or about 100 PSI to about 120 PSI, about 140 PSI, about 150 PSI, about 160 PSI, about 180 PSI, about 200 PSI, about 220 PSI, about 250 PSI, about 300 PSI, or greater to the rolled anode-sacrificial substrate bundle 200 during the rolling or winding process. In some examples, the idle roller 320 can apply a force in a range from about 40 PSI to about 300 PSI, about 50 PSI to about 300 PSI, about 80 PSI to about 300 PSI, about 100 PSI to about 300 PSI, about 150 PSI to about 300 PSI, about 200 PSI to about 300 PSI, about 250 PSI to about 300 PSI, about 40 PSI to about 200 PSI, about 50 PSI to about 200 PSI, about 80 PSI to about 200 PSI, about 100 PSI to about 200 PSI, about 150 PSI to about 200 PSI, about 180 PSI to about 200 PSI, about 40 PSI to about 150 PSI, about PSI to about 150 PSI, about 80 PSI to about 150 PSI, about 100 PSI to about 150 PSI, or about 120 PSI to about 150 PSI to the rolled anode-sacrificial substrate bundle 200 during the rolling or winding process.

The process system 100 includes one, two, or more heating sources 140, such as infrared lamps, filament lamps, or other types of lamps, contained within the processing region 104. Each of the heating sources 140 (e.g., infrared lamps) can independently be positioned at and direct radiant energy to the sacrificial substrate 110, the anode substrate 120, the rolled anode-sacrificial substrate bundle 200, or any combination thereof. For example, a first heating source 140 can be positioned at and direct radiant energy to the sacrificial substrate 110 between the roller 114 and the rewinder roller 130, a second heating source 140 can be positioned at and direct radiant energy to the anode substrate 120 between the roller 124 and the rewinder roller 130, and a third heating source 140 can be positioned at and direct radiant energy to the rolled anode-sacrificial substrate bundle 200 on the rewinder roller 130.

One or more thermocouples 142 can also be contained within the processing region 104. Each of the thermocouples 142 can be couple to a respective heating sources 140 and can be used to monitor the temperatures of the heating sources 140 to prevent overheating. In one or more examples, the heating sources 140 are vacuum-rated infrared lamps and can be sustained at the process pressure of less than 760 Torr, such as about 1×10⁻⁶ mTorr to about 1×10⁻³ mTorr for at least 24 hours. For example, the heating sources 140 can be sustained at the process pressure of less than 760 Torr for about 24 hours or longer, such as greater than 24 hours to about 48 hours, about 26 hours to about 40 hours, about 30 hours to about 36 hours.

The process system 100 includes one, two, or more pyrometers 144 contained within the processing region 104. Each of the pyrometers 144 can independently be positioned to monitor or otherwise receive the temperatures of the anode substrate 120 and/or the rolled anode-sacrificial substrate bundle 200. For example, a first pyrometer 144 can be positioned at and monitor the temperature of the anode substrate 120 between the roller 124 and the rewinder roller 130 and a second pyrometer 144 can be positioned at and monitor the temperature of the rolled anode-sacrificial substrate bundle 200 on the rewinder roller 130.

In one or more embodiments, methods for producing or otherwise forming lithium intercalated anodes are provided and include introducing the sacrificial substrate 110 and the anode substrate 120 into the processing region 104 within the chamber 102. The method also includes combining the sacrificial substrate 110 and the anode substrate 120 overlapping one another around the rewinder roller 130 within the processing region 104 during a rolling or winding process. The method further includes rotating the rewinder roller 130 to wind the sacrificial substrate 110 and the anode substrate 120 together to produce the rolled anode-sacrificial substrate bundle 200 while continuing to introduce the sacrificial substrate 110 and the anode substrate 120 into the processing region 104 during the rolling or winding process. The method also includes heating the sacrificial substrate 110, the anode substrate 120, and/or the rolled anode-sacrificial substrate bundle 200 while rotating the rewinder roller 130 and applying a force to the rolled anode-sacrificial substrate bundle 200 via the dead or idle roller 320 during the rolling or winding process.

In some examples, the processing region 104 is maintained under a vacuum while combining the sacrificial substrate 110 and the anode substrate 120 and rotating the rewinder roller 130. For example, the processing region 104 is maintained at a pressure of less than 760 Torr, such as about 1×10⁻⁶ mTorr to about 1×10⁻³ mTorr, while combining the sacrificial substrate 110 and the anode substrate 120 and rotating the rewinder roller 130, as well as while storing the rolled anode-sacrificial substrate bundle 200. In some examples, the processing region 104 is maintained at a pressure of less than 760 Torr, such as at a pressure of about 5×10⁻⁷ mTorr, about 1×10⁻⁶ mTorr, about 5×10⁻⁶ mTorr, or about 1×10⁻⁵ mTorr to about 5×10⁻⁵ mTorr, about 1×10⁻⁴ mTorr, about 5×10⁻⁴ mTorr, about 1×10⁻³ mTorr, about 5×10⁻³ mTorr, or about 1×10⁻² mTorr while combining the sacrificial substrate 110 and the anode substrate 120 and rotating the rewinder roller 130, as well as while storing the rolled anode-sacrificial substrate bundle 200.

In one or more embodiments, the method also includes transferring at least a portion of the lithium metal from the sacrificial substrate 110 to the anode substrate 120 and absorbing the lithium metal into the anode substrate 120 to produce the lithium intercalated anode substrate.

In some embodiments, the method includes maintaining the rolled anode-sacrificial substrate bundle 200 under vacuum and/or heated for a predetermined time while producing the lithium intercalated anode substrate. The predetermined time or period can be about 1 hour, about 2 hours, about 3 hours, about 5 hours, about 8 hours, or about 10 hours to about 12 hours, about 15 hours, about 20 hours, about 24 hours, about 28 hours, about 30 hours, about 36 hours, about 48 hours, or longer. For example, the rolled anode-sacrificial substrate bundle 200 can be maintained under vacuum and/or heated for a time or period in a range from about 1 hour to about 36 hours, about 2 hours to about 30 hours, about 2 hours to about 24 hours, about 2 hours to about 20 hours, about 2 hours to about 18 hours, about 2 hours to about 15 hours, about 2 hours to about 12 hours, about 2 hours to about 10 hours, about 2 hours to about 8 hours, about 2 hours to about 5 hours, about 2 hours to about 4 hours, about 4 hours to about 30 hours, about 5 hours to about 30 hours, about 8 hours to about 30 hours, about 10 hours to about 30 hours, about 12 hours to about 30 hours, about 15 hours to about 30 hours, about 18 hours to about 30 hours, about 20 hours to about 30 hours, about 24 hours to about 30 hours, or about 26 hours to about 30 hours while producing the lithium intercalated anode substrate. In other examples, the rolled anode-sacrificial substrate bundle 200 is heated under vacuum for a period in a range from about 2 hours to about 36 hours, about 8 hours to about 24 hours, or about 10 hours to about 18 hours.

In some embodiments, the rolled anode-sacrificial substrate bundle 200 is heated and/or maintained at a predetermined temperature by one, two, three, or more heating sources 140, such as one or more infrared lamps, positioned within the processing region 104. In one or more embodiments, each of the sacrificial substrate 110, the anode substrate 120, and/or the rolled anode-sacrificial substrate bundle 200 can independently be heated to a predetermined temperature during the winding or rolling process. The predetermined temperature can be in a range from about 25° C., about 30° C., about 35° C., about 40° C., about 50° C., about 60° C., about 70° C., about 75° C., about 80° C., about 90° C., about 95° C., or about 100° C. to about 105° C., about 110° C., about 120° C., about 125° C., about 130° C., about 140° C., about 150° C., about 160° C., about 180° C., about 190° C., about 200° C., about 220° C., about 240° C., about 250° C., or about 300° C. For example, each of the sacrificial substrate 110, the anode substrate 120, and/or the rolled anode-sacrificial substrate bundle 200 can independently be heated to a temperature in a range from about 25° C. to about 300° C., about 25° C. to about 250° C., about 25° C. to about 200° C., about 50° C. to about 200° C., about 80° C. to about 200° C., about 100° C. to about 200° C., about 125° C. to about 200° C., about 150° C. to about 200° C., about 175° C. to about 200° C., about 30° C. to about 180° C., about 40° C. to about 170° C., about 50° C. to about 150° C., about 60° C. to about 150° C., about 70° C. to about 150° C., about 80° C. to about 150° C., about 90° C. to about 150° C., about 100° C. to about 150° C., about 110° C. to about 150° C., about 120° C. to about 150° C., about 130° C. to about 150° C., about 50° C. to about 140° C., about 50° C. to about 130° C., about 50° C. to about 120° C., about 50° C. to about 110° C., about 50° C. to about 100° C., about 50° C. to about 90° C., about 50° C. to about 80° C., or about 50° C. to about 70° C. during the winding or rolling process.

In other embodiments, the method further includes unwinding the rolled anode-sacrificial substrate bundle 200 and separating the lithium intercalated anode substrate from the base foil 108 of the sacrificial substrate 110. The base foil 108 can still contain a portion of the lithium coating 111 or lithium metal on the upper and lower surfaces 108a, 108b. Alternatively, the base foil 108 can be free or substantially free of the lithium coating 111 or lithium metal on the upper and lower surfaces 108a, 108b.

In one or more embodiments, a method for producing or forming the lithium intercalated anode includes introducing the sacrificial substrate 110 into the processing region 104 within the chamber 102, where the sacrificial substrate 110 can be or contain the base foil 108 having an upper surface 108a opposite a lower surface 108b and a lithium coating 111 disposed on the upper and lower surfaces 108a, 108b. The method also includes introducing the anode substrate 120 into the processing region 104 within the chamber 102. The method further includes rotating a rewinder roller 130 within the processing region 104 to wind the sacrificial substrate 110 and the anode substrate 120 together and overlapping one another around to produce a rolled anode-sacrificial substrate bundle 200 while continuing to introduce the sacrificial substrate 110 and the anode substrate 120 into the processing region 104 during a winding or rolling process. The processing region 104 is maintained at a vacuum, such as at a pressure of less than 760 Torr, such as about 1×10⁻⁶ mTorr to about 1×10⁻³ mTorr while producing the rolled anode-sacrificial substrate bundle 200. The method also includes heating the sacrificial substrate 110, the anode substrate 120, and/or the rolled anode-sacrificial substrate bundle 200 while rotating the rewinder roller 130 and applying a force to the rolled anode-sacrificial substrate bundle 200 via the dead or idle roller 320 during the winding or rolling process. The method further includes transferring at least a portion of the lithium metal from the sacrificial substrate 110 to the anode substrate 120 while within the rolled anode-sacrificial substrate bundle 200 and absorbing the lithium metal into the anode substrate 120 to produce a lithium intercalated anode substrate.

Embodiments of the present disclosure further relate to any one or more of the following examples 1-48:
1. A method of forming a lithium intercalated anode, comprising: introducing a sacrificial substrate into a processing region within a chamber, wherein the sacrificial substrate comprises a base foil having an upper surface opposite a lower surface and a lithium coating disposed on the upper and lower surfaces; introducing an anode substrate comprising graphite into the processing region within the chamber; combining the sacrificial substrate and the anode substrate overlapping one another around a rewinder roller within the processing region during a rolling process; rotating the rewinder roller to wind the sacrificial substrate and the anode substrate together to produce a rolled anode-sacrificial substrate bundle while continuing to introduce the sacrificial substrate and the anode substrate into the processing region during the rolling process; heating the sacrificial substrate, the anode substrate, and/or the rolled anode-sacrificial substrate bundle while rotating the rewinder roller during the rolling process; and applying a force to the rolled anode-sacrificial substrate bundle via an idle roller during the rolling process.
2. The method according to example 1, further comprising: transferring at least a portion of the lithium metal from the sacrificial substrate to the anode substrate; and absorbing the lithium metal into the anode substrate to produce a lithium intercalated anode substrate.
3. The method according to example 1 or 2, further comprising maintaining the rolled anode-sacrificial substrate bundle under vacuum for about 2 hours to about 24 hours while producing the lithium intercalated anode substrate.
4. The method according to example 1 or 2, further comprising unwinding the rolled anode-sacrificial substrate bundle and separating the lithium intercalated anode substrate from the base foil of the sacrificial substrate.
5. The method according to any one of examples 1-4, wherein the processing region is maintained under a vacuum while combining the sacrificial substrate and the anode substrate and rotating the rewinder roller.
6. The method according to any one of examples 1-5, wherein the processing region is maintained at a pressure in a range from about 1×10⁻⁶ mTorr to about 1×10⁻³ mTorr while combining the sacrificial substrate and the anode substrate and rotating the rewinder roller.
7. The method according to any one of examples 1-6, wherein the sacrificial substrate, the anode substrate, and/or the rolled anode-sacrificial substrate bundle are heated to a temperature of about 50° C. to about 200° C. during the rolling process.
8. The method according to any one of examples 1-7, wherein the rolled anode-sacrificial substrate bundle is heated under vacuum for a period from about 2 hours to about 36 hours.
9. The method according to any one of examples 1-8, wherein the rolled anode-sacrificial substrate bundle is heated by one or more infrared lamps positioned within the processing region.
10. The method according to any one of examples 1-9, wherein the force applied to the rolled anode-sacrificial substrate bundle by the idle roller is about 80 pounds per square inch (PSI) to about 200 PSI.
11. The method according to any one of examples 1-10, further comprising: radially moving the idle roller away from the rewinder roller as the rolled anode-sacrificial substrate bundle is produced from the sacrificial substrate and the anode substrate; while maintaining the force applied to the rolled anode-sacrificial substrate bundle.
12. The method according to any one of examples 1-11, wherein the chamber comprises a calendaring system which comprises the idle roller.
13. The method according to any one of examples 1-12, wherein the calendaring system further comprises two pivot arms, and wherein each of the pivot arms comprises a sliding slot configured to support the idle roller.
14. The method according to any one of examples 1-13, wherein the calendaring system further comprises two casters, wherein each caster is coupled on opposite ends of the idle roller, and wherein each caster is configured to travel within a respective sliding slot on each of the pivot arms.
15. The method according to any one of examples 1-14, wherein the base foil of the sacrificial substrate comprises a metal or a polymeric material.
16. The method according to any one of examples 1-15, wherein the base foil of the sacrificial substrate comprises a metal selected from copper, a copper alloy, nickel, a nickel alloy, a stainless steel alloy, alloys thereof, or any combination thereof.
17. The method according to any one of examples 1-16, wherein the base foil of the sacrificial substrate comprises a polymeric material selected from polyethylene terephthalate (PET), polypropylene (PP), copolymers thereof, elastomers thereof, or any combination thereof.
18. The method according to any one of examples 1-17, wherein the anode substrate comprises a graphite foil, a silicon-graphite material, a silicon oxide-graphite material, or any combination thereof.
19. The method according to any one of examples 1-18, wherein the rewinder roller and the processing region are both in a rewinder chamber.
20. The method according to any one of examples 1-19, wherein the rewinder chamber is part of a process system further comprising a process chamber coupled to and between an unwinder chamber and the rewinder chamber.
21. A method of forming a lithium intercalated anode, comprising: introducing a sacrificial substrate into a processing region within a chamber, wherein the sacrificial substrate comprises a base foil having an upper surface opposite a lower surface and a lithium coating disposed on the upper and lower surfaces; introducing an anode substrate into the processing region within the chamber; rotating a rewinder roller within the processing region to wind the sacrificial substrate and the anode substrate together and overlapping one another around to produce a rolled anode-sacrificial substrate bundle while continuing to introduce the sacrificial substrate and the anode substrate into the processing region during a rolling process, wherein the processing region is maintained at a pressure of less than 760 Torr while producing the rolled anode-sacrificial substrate bundle; heating the sacrificial substrate, the anode substrate, and/or the rolled anode-sacrificial substrate bundle while rotating the rewinder roller during the rolling process; applying a force to the rolled anode-sacrificial substrate bundle via an idle roller during the rolling process; transferring at least a portion of the lithium metal from the sacrificial substrate to the anode substrate; and absorbing the lithium metal into the anode substrate to produce a lithium intercalated anode substrate.
22. The method according to example 21, wherein the processing region is maintained at a pressure in a range from about 1×10⁻⁶ mTorr to about 1×10⁻³ mTorr while producing the rolled anode-sacrificial substrate bundle.
23. The method according to example 21 or 22, further comprising maintaining the rolled anode-sacrificial substrate bundle under vacuum for about 2 hours to about 24 hours while producing the lithium intercalated anode substrate.
24. The method according to any one of examples 21-23, further comprising unwinding the rolled anode-sacrificial substrate bundle and separating the lithium intercalated anode substrate from the sacrificial substrate.
25. The method according to any one of examples 21-24, wherein the sacrificial substrate, the anode substrate, and/or the rolled anode-sacrificial substrate bundle are heated to a temperature of about 50° C. to about 200° C. during the rolling process.
26. The method according to any one of examples 21-25, wherein the rolled anode-sacrificial substrate bundle is heated under vacuum for a period from about 2 hours to about 36 hours.
27. The method according to any one of examples 21-26, wherein the rolled anode-sacrificial substrate bundle is heated by one or more infrared lamps positioned within the processing region.
28. The method according to any one of examples 21-27, wherein the force applied to the rolled anode-sacrificial substrate bundle by the idle roller is about 80 pounds per square inch (PSI) to about 200 PSI.
29. The method according to any one of examples 21-28, further comprising: radially moving the idle roller away from the rewinder roller as the rolled anode-sacrificial substrate bundle is produced from the sacrificial substrate and the anode substrate; while maintaining the force applied to the rolled anode-sacrificial substrate bundle.
30. The method according to any one of examples 21-29, wherein the chamber comprises a calendaring system which comprises the idle roller.
31. The method according to any one of examples 21-30, wherein the calendaring system further comprises two pivot arms, and wherein each of the pivot arms comprises a sliding slot configured to support the idle roller.
32. The method according to any one of examples 21-31, wherein the calendaring system further comprises two casters, wherein each caster is coupled on opposite ends of the idle roller, and wherein each caster is configured to travel within a respective sliding slot on each of the pivot arms.
33. The method according to any one of examples 21-32, wherein the base foil of the sacrificial substrate comprises a metal or a polymeric material.
34. The method according to any one of examples 21-33, wherein the base foil of the sacrificial substrate comprises a metal selected from copper, a copper alloy, nickel, a nickel alloy, a stainless steel alloy, alloys thereof, or any combination thereof.
35. The method according to any one of examples 21-34, wherein the base foil of the sacrificial substrate comprises a polymeric material selected from polyethylene terephthalate (PET), polypropylene (PP), copolymers thereof, elastomers thereof, or any combination thereof.
36. The method according to any one of examples 21-35, wherein the anode substrate comprises a graphite foil, a silicon-graphite material, a silicon oxide-graphite material, or any combination thereof.
37. The method according to any one of examples 21-36, wherein the rewinder roller and the processing region are both in a rewinder chamber.
38. The method according to any one of examples 21-37, wherein the rewinder chamber is part of a process system further comprising a process chamber coupled to and between an unwinder chamber and the rewinder chamber.
39. A process system for forming a lithium intercalated anode, comprising: a chamber having a processing region therein and configured to maintained the processing region at a pressure in a range from about 1×10⁻⁶ mTorr to about 1×10⁻³ mTorr; a first source coupled to the chamber and containing a sacrificial substrate comprising a base foil having an upper surface opposite a lower surface and a lithium coating disposed on the upper and lower surfaces; a second source coupled to the chamber and containing an anode substrate comprising graphite; a rewinder roller disposed within the processing region and configured to receive and wind together the sacrificial substrate and the anode substrate to produce a rolled anode-sacrificial substrate bundle; a calendaring system comprising an idle roller configured to apply a force to the rolled anode-sacrificial substrate bundle; and one or more infrared lamps contained within the processing region and positioned at the sacrificial substrate, the anode substrate, and/or the rolled anode-sacrificial substrate bundle.
40. The process system according to example 39, wherein the idle roller is configured to radially move away from the rewinder roller as the rolled anode-sacrificial substrate bundle is produced from the sacrificial substrate and the anode substrate while maintaining the force applied to the rolled anode-sacrificial substrate bundle.
41. The process system according to example 39 or 40, wherein the calendaring system further comprises two pivot arms, and wherein each of the pivot arms comprises a sliding slot configured to support the idle roller.
42. The process system according to any one of examples 39-41, wherein the calendaring system further comprises two casters, wherein each caster is coupled on opposite ends of the idle roller, and wherein each caster is configured to travel within a respective sliding slot on each of the pivot arms.
43. The process system according to any one of examples 39-42, wherein the force applied to the rolled anode-sacrificial substrate bundle by the idle roller is about 80 pounds per square inch (PSI) to about 200 PSI.
44. The process system according to any one of examples 39-43, wherein the sacrificial substrate, the anode substrate, and/or the rolled anode-sacrificial substrate bundle are heated to a temperature of about 50° C. to about 200° C. during the rolling process.
45. The process system according to any one of examples 39-44, wherein the rewinder roller and the processing region are both in a rewinder chamber.
46. The process system according to any one of examples 39-45, wherein the rewinder chamber is part of a process system further comprising a process chamber coupled to and between an unwinder chamber and the rewinder chamber.
47. The process system according to any one of examples 39-45, configured to conduct any of the methods of examples 1-38.
48. A process system configured to conduct any of the methods of examples 1-38.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation can be included in any value provided herein.

Certain embodiments and features have been described using a set of numerical minimum values and a set of numerical maximum values. It should be appreciated that ranges including the combination of any two values, e.g., the combination of any minimum value with any maximum value, the combination of any two minimum values, and/or the combination of any two maximum values are contemplated unless otherwise indicated. Certain minimum values, maximum values, and ranges appear in one or more claims below.

What is claimed is:

1. A method of forming a lithium intercalated anode, comprising:
introducing a sacrificial substrate into a processing region within a chamber, wherein the sacrificial substrate comprises a base foil having an upper surface opposite a lower surface and a lithium coating disposed on the upper and lower surfaces;
introducing an anode substrate comprising graphite into the processing region within the chamber;
combining the sacrificial substrate and the anode substrate overlapping one another around a rewinder roller within the processing region during a rolling process;
rotating the rewinder roller to wind the sacrificial substrate and the anode substrate together to produce a rolled anode-sacrificial substrate bundle while continuing to introduce the sacrificial substrate and the anode substrate into the processing region during the rolling process;
heating the sacrificial substrate, the anode substrate, and/or the rolled anode-sacrificial substrate bundle while rotating the rewinder roller during the rolling process; and
applying a force to the rolled anode-sacrificial substrate bundle via an idle roller during the rolling process.

2. The method of claim 1, further comprising:
transferring at least a portion of the lithium metal from the sacrificial substrate to the anode substrate;
absorbing the lithium metal into the anode substrate to produce a lithium intercalated anode substrate; and
maintaining the rolled anode-sacrificial substrate bundle under vacuum for about 2 hours to about 24 hours while producing the lithium intercalated anode substrate.

3. The method of claim 1, further comprising:
transferring at least a portion of the lithium metal from the sacrificial substrate to the anode substrate;
absorbing the lithium metal into the anode substrate to produce a lithium intercalated anode substrate; and
unwinding the rolled anode-sacrificial substrate bundle and separating the lithium intercalated anode substrate from the base foil of the sacrificial substrate.

4. The method of claim 1, wherein the processing region is maintained at a pressure in a range from about 1×10⁻⁶ mTorr to about 1×10⁻³ mTorr while combining the sacrificial substrate and the anode substrate and rotating the rewinder roller.

5. The method of claim 1, wherein the sacrificial substrate, the anode substrate, and/or the rolled anode-sacrificial substrate bundle are heated to a temperature of about 50° C. to about 200° C. during the rolling process.

6. The method of claim 1, wherein the rolled anode-sacrificial substrate bundle is heated under vacuum for a period from about 2 hours to about 36 hours by one or more infrared lamps positioned within the processing region.

7. The method of claim 1, further comprising:
radially moving the idle roller away from the rewinder roller as the rolled anode-sacrificial substrate bundle is produced from the sacrificial substrate and the anode substrate; while
maintaining the force applied to the rolled anode-sacrificial substrate bundle.

8. The method of claim 1, wherein the chamber comprises a calendaring system which comprises the idle roller, wherein the calendaring system further comprises two pivot arms, and wherein each of the pivot arms comprises a sliding slot configured to support the idle roller.

9. The method of claim 8, wherein the calendaring system further comprises two casters, wherein each caster is coupled on opposite ends of the idle roller, and wherein each caster is configured to travel within a respective sliding slot on each of the pivot arms.

10. The method of claim 1, wherein the base foil of the sacrificial substrate comprises a metal selected from copper, a copper alloy, nickel, a nickel alloy, a stainless steel alloy, alloys thereof, or any combination thereof.

11. The method of claim 1, wherein the base foil of the sacrificial substrate comprises a polymeric material selected from polyethylene terephthalate (PET), polypropylene (PP), copolymers thereof, elastomers thereof, or any combination thereof.

12. The method of claim 1, wherein the anode substrate comprises a graphite foil, a silicon-graphite material, a silicon oxide-graphite material, or any combination thereof.

13. The method of claim 1, wherein the rewinder roller and the processing region are both in a rewinder chamber, wherein the rewinder chamber is part of a process system further comprising a process chamber coupled to and between an unwinder chamber and the rewinder chamber.

14. A method of forming a lithium intercalated anode, comprising:
introducing a sacrificial substrate into a processing region within a chamber, wherein the sacrificial substrate comprises a base foil having an upper surface opposite a lower surface and a lithium coating disposed on the upper and lower surfaces;
introducing an anode substrate into the processing region within the chamber;
rotating a rewinder roller within the processing region to wind the sacrificial substrate and the anode substrate together and overlapping one another around to produce a rolled anode-sacrificial substrate bundle while continuing to introduce the sacrificial substrate and the anode substrate into the processing region during a rolling process, wherein the processing region is maintained at a pressure of less than 760 Torr while producing the rolled anode-sacrificial substrate bundle;
heating the sacrificial substrate, the anode substrate, and/or the rolled anode-sacrificial substrate bundle while rotating the rewinder roller during the rolling process;
applying a force to the rolled anode-sacrificial substrate bundle via an idle roller during the rolling process;
transferring at least a portion of the lithium metal from the sacrificial substrate to the anode substrate; and
absorbing the lithium metal into the anode substrate to produce a lithium intercalated anode substrate.

15. The method of claim 14, wherein the processing region is maintained at a pressure in a range from about 1×10⁻⁶ mTorr to about 1×10⁻³ mTorr while producing the rolled anode-sacrificial substrate bundle.

16. The method of claim 14, wherein the rolled anode-sacrificial substrate bundle is heated under vacuum for a period from about 2 hours to about 36 hours by one or more infrared lamps positioned within the processing region.

17. The method of claim 14, further comprising:
radially moving the idle roller away from the rewinder roller as the rolled anode-sacrificial substrate bundle is produced from the sacrificial substrate and the anode substrate; while
maintaining the force applied to the rolled anode-sacrificial substrate bundle.

18. The method of claim 14, wherein the chamber comprises a calendaring system which comprises the idle roller, wherein the calendaring system further comprises two pivot arms, and wherein each of the pivot arms comprises a sliding slot configured to support the idle roller.

19. The method of claim 14, wherein the rewinder roller and the processing region are both in a rewinder chamber, and wherein the rewinder chamber is part of a process system further comprising a process chamber coupled to and between an unwinder chamber and the rewinder chamber.

20. A process system for forming a lithium intercalated anode, comprising:
a chamber having a processing region therein and configured to maintained the processing region at a pressure in a range from about 1×10⁻⁶ mTorr to about 1×10⁻³ mTorr;
a first source coupled to the chamber and containing a sacrificial substrate comprising a base foil having an upper surface opposite a lower surface and a lithium coating disposed on the upper and lower surfaces;
a second source coupled to the chamber and containing an anode substrate comprising graphite;
a rewinder roller disposed within the processing region and configured to receive and wind together the sacrificial substrate and the anode substrate to produce a rolled anode-sacrificial substrate bundle;
a calendaring system comprising an idle roller configured to apply a force to the rolled anode-sacrificial substrate bundle; and
one or more infrared lamps contained within the processing region and positioned at the sacrificial substrate, the anode substrate, and/or the rolled anode-sacrificial substrate bundle.
